(19) United States
(12) Patent Application Publication
(10) Pub. No.: US 2014/0277965 A1
(43) Pub. Date: Sep. 18, 2014

(54) GPS Planting System

(71) Applicants: Mark Miller, Corvallis, OR (US); Doug Edmonds, Philomath, OR (US); Sarah Miller, Corvallis, OR (US); Kirby Headrick, Corvallis, OR (US); Lisa Miller, Corvallis, OR (US)

(72) Inventors: Mark Miller, Corvallis, OR (US); Doug Edmonds, Philomath, OR (US); Sarah Miller, Corvallis, OR (US); Kirby Headrick, Corvallis, OR (US); Lisa Miller, Corvallis, OR (US)

(21) Appl. No.: 14/218,789

(22) Filed: Mar. 18, 2014

Related U.S. Application Data
(60) Provisional application No. 61/803,034, filed on Mar. 18, 2013.

(51) Int. Cl. A01C 7/10; A01B 69/04; A01C 21/00

(52) U.S. Cl. CPC A01C 7/102; A01C 21/005; A01B 69/008
USPC 701/50

(57) ABSTRACT

A seed planting system that plants seeds at a precise location within a field to allow for efficient in-row cultivation is provided herein. The planting system receives a GPS signal, processes that signal to determine the precise time at which to dispense a seed from an agricultural seeder or planter, then generates an actuation signal that is transmitted to the seeder or planter. GPS signals are also processed to steer the seeder or planter so that seeds are properly placed within the field.

### CROSS-REFERENCES TO RELATED APPLICATIONS

This application claims priority to U.S. Provisional Patent Application Ser. No. 61/803,034 filed on March 18^{th}, entitled “GPS planting system”, the disclosure of which is hereby incorporated by reference.

### BACKGROUND OF THE INVENTION

The present invention relates to methodologies for planting crops, and more specifically, implementing a global positioning system to advance the precision of said planting.

### BACKGROUND OF THE INVENTION

Since the advent of human-cultivated plant crops, there have been many advancements in the art. The commercial growing of agricultural plants is a trade-off between dense planting for increased crop yield per area and the need to facilitate the labor of operation. Plants are grown in rows, separated by pathways allowing access for attending and harvesting. The distance between individual plants depends on the species and is set such as to prevent mutual light shading between the foliage of neighboring individuals; the distance between rows within a plant array is essentially the distance between the plants within a row. Typically, however, the distance between rows is slightly larger, for example 40 cm between rows, and 25 cm within a row in tomatoes, however these can vary between different species or different growers.

While in the past the growth of agricultural plants has benefitted from improvements in base fertilization and liquid feeding programs and the addition of peat mixes to the soil, it is the purpose of the present invention to provide a further increase in crop yield by providing a method for increasing the density of plants per unit area by means of controlling their foliage, which on the one hand will suffice for efficient plant growth and on the other hand will increase the number of plants per unit area.

Currently, farmers endeavoring to remove weeds from their organic fields tend to use either hand labor to hoe out the weeds, or a mechanical cultivator pulled by a tractor. Both these solutions are sufficient in their own rights, but may not be preferred. Hand labor is a time-honored solution, and proves itself good at removing the weeds all over the field, even weeds that are located right next to the plant. Unfortunately, this method tends to be very time consuming, and becomes expensive in terms of wages for the laborers. Moreover, it is impractical in large fields, due to the large numbers of workers which are required for weed abatement. This is also problematic for farms that do not have a large labor force on hand, as a farm will need to spend extra resources to acquire a temporary labor force, and possibly managers to monitor said laborers.

Mechanical cultivation is well known within the art, and has been shown to be effective at removing unwanted weeds between crop rows. This method generally sees a tractor pulling a device to till the soil between the rows. One benefit of mechanical cultivation is that it only requires a single person to operate both the tractor, and the cultivator. Unfortunately, this method is usually not precise enough be used to remove the weeds between plants within the TOW.

One response to the inability of most mechanical cultivators to remove weeds within the planted row, is to use a special in-row cultivator. The cultivator slowly drives across the rows, and whenever the cultivator is about to run over a plant, workers stationed on the back of the cultivator will move one of the cultivation units away from the plant, and then let it fall back into position. While this process works, it necessitates a special cultivator, hired laborers, and must be done at a very slow speed. This increases the cost of wages and time.

In order to facilitate weed removal via in-row cultivators, it is beneficial to use special planters which can plant the seeds in a grid pattern. A regular cultivator can be used to drive both down the rows and subsequently, across them, negating the need for often-expensive specialty machinery. These planters rely on a cable or rope that is stretched along the length of the field that has knots, metal clips, or any plurality of indicators, spaced the width of the cross rows. The planter is attached to this cable, and as it is pulled down the field, at every knot or clip, it is tripped to drop seeds. Unfortunately, this system requires moving the cable to the next row after every pass; a task that quickly becomes very cumbersome when only one person is planting. Another flaw is that the accuracy is highly dependent the cable's location.

Global positioning systems are known within the art. The Global Positioning System (GPS) is a satellite-based radio navigation system capable of providing continuous position, velocity, and time information to an unlimited number of users throughout the world. The global positioning system includes a satellite constellation in orbit around the earth. The satellites transmit orbit data. By measuring the ranges from the satellites to a low cost global positioning system receiver, the three-dimensional location of the receiver can be accurately located, provided that the signals from a plurality of satellites, typically four or more satellites, can be received.

Applications of GPS in vehicles, such as automobiles, trucks, vans, sport utility vehicles, minivans, and the like, have been developed. Examples of present applications of GPS in vehicles include automatic navigation systems for driver assistance in route guidance, intelligent vehicle highway systems for road tolling and traffic flow assessment and route diversions, as well as automatic vehicle location systems for monitoring a vehicle's position and movement which is provided to a fleet control center.

It could be said there lies a need for a GPS-based planting system which can be retrofitted to existing equipment, reducing costs to the end user.

The present invention allows the user to plant precise grid-patterned crops with the aid of GPS, while being able to be retrofitted to existing equipment.

### BRIEF SUMMARY OF THE INVENTION

The present invention provides a seed planting system that plants seeds in a precise grid within a field to allow for efficient in-row cultivation. The planting system receives a GPS signal, processes that signal to determine the precise time at which to dispense a seed from an agricultural seeder or planter, then generates an actuation signal that is transmitted to the seeder or planter. GPS signals are also processed to steer the seeder or planter so that seeds are properly placed within the field.

In one preferred embodiment of the present invention, a GPS receiver receives GPS signals and transfers those signals to a microprocessor. The microprocessor receives the GPS signals from the receiver and calculates the time until the next seed must be dropped. When seeds must be dropped, the microprocessor sends an actuation signal to a seeder or planter causing seed doors to actuate and the seeds are dispensed.

In another preferred embodiment, in addition to controlling the precise timing of seed dispensation, the microprocessor uses the GPS signals to generate steering commands that are used to steer a tractor that is towing the seeder.

Other novel features which are characteristics of the invention, as to organization and method of operation, together with further and advantages thereof will be better understood from the following description considered in connection with the accompanying figures, in which preferred embodiments of the invention are illustrated by way of example. It is to be expressly understood, however, that the figures are for illustration and description only and are not intended as a definition of the limits of the invention. The various features of novelty which characterize the invention are pointed out with particularity in the following description. The invention resides not in any one of these features taken alone, but rather in the particular combination of all of its structures for the functions specified.

### BRIEF DESCRIPTION OF THE FIGURES

FIG. 1 shows a top level block diagram of the components of a GPS planting system as according to one embodiment of the present invention;

FIG. 2 shows a block diagram of the modes of a GPS planting system as according to one embodiment of the present invention;

FIG. 3 shows a flowchart of the planting mode of a GPS planting system of a GPS planting system as according to one embodiment of the present invention;

FIG. 4 shows a flowchart of a seed drop routine which is called by the planting mode of a GPS planting system to drop seeds as according to one embodiment of the present invention;

FIG. 5 shows a front elevation view of an exemplary tractor and planter that are used with a GPS planting system as according to one embodiment of the present invention;

FIG. 6 shows a front elevation view of an exemplary planter seed tube of a GPS planting system as according to one embodiment of the present invention;

FIG. 7 shows a plan view of an exemplary seed door opening and shutting sequence as according to one embodiment of the present invention; and

FIG. 8 shows a front elevation view of an exemplary planter seed tube of a GPS planting system as according to one embodiment of the present invention.

A further understanding of the present invention can be obtained by reference to a preferred embodiment set forth in the accompanying description. Although the illustrated embodiments are merely exemplary of methods for carrying out the present invention, both the organization and method of operation of the invention, in general, together with further objectives and advantages thereof, may be more easily understood by reference to the illustrations and the following description. The figures are not intended to limit the scope of this invention, but merely to clarify and exemplify the invention.

### DETAILED DESCRIPTION OF THE INVENTION

In the following detailed description, reference is made to specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method, system, and apparatus include the discussed feature, advantage or mode of operation. The following description of the preferred embodiment is merely exemplary in nature and is in no way intended to limit the invention, its application, or use.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter. Those skilled in the art will appreciate that the conception upon which this disclosure is based may be readily utilized as a basis for the designing of other structures, methods and systems for carrying out the purposes of the present invention. It is important, therefore, that any embodiments of the present invention be regarded as including such equivalent constructions insofar as they do not depart from the spirit and scope of the present invention.

In a manner described below, the data processing aspects of the present invention may be implemented, in part, by programs that are executed by a computer. The term “computer” as used herein includes any device that electronically executes one or more programs, such as personal computers (PCs), hand-held devices, multi-processor systems, microprocessor-based programmable consumer electronics, network PCs, minicomputers, mainframe computers, routers, gateways, hubs and the like. The term “program” as used herein includes applications, routines, objects, components, data structures and the like that perform particular tasks or implement particular abstract data types. The term “program” as used herein further may connote a single program application or module or multiple applications or program modules acting in concert. The data processing aspects of the invention also may be employed in distributed computing environments, where tasks are performed by remote processing devices that are linked through a communications network. In a distributed computing environment, programs may be located in both local and remote memory storage devices.

Further, the purpose of the Abstract herein is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application nor is it intended to be limiting as to the scope of the invention in any way.

Referring now to the present invention, there is introduced a GPS planting system that may be used to precisely control the location of seeds when planting. For the purpose of clarity, all like elements mentioned in this description will have the same designations. The terms “GPS planting system”, “planting system”, “system”, “invention”, and “present invention” may be used interchangeably. In addition to the functions, features, components, and abilities of the invention already discussed in this specification, the invention may also have, but not be limited to, the following features contained within the description below.

The present invention solves the shortcomings of the prior art by providing a GPS planting system that may be used with agricultural equipment to control the placement of crops planted in a field. The preferred embodiments described below set forth the present invention in greater detail.

Referring now to FIG. 1, there is shown a top level block diagram of the components of a GPS planting system as according to one embodiment of the present invention. Connections between components are illustrated by arrows within the block diagram. These connections can be simple electrical connections, or any connection capable of transmitting data, such as serial connections, data packet communications connections, or other means for transmitting digital or analog information. The data packets transmitted between some components of the system can include, but are not limited to, GPS data packets. Various protocols, such as the National Marine Electronics Association (NMEA) data protocol may be used to transmit data within the GPS planting system.

The GPS planting system comprises a GPS antenna (100) that receives global positioning system signals and transfers those signals to a microprocessor (104). The position of the GPS antenna (100) is the point in the system where the GPS coordinates are determined. The GPS antenna (100) can be positioned anywhere in the GPS planting system, but if not placed directly above where seeds (112) are dispensed, then calculations must be made to compensate for the offset from where the GPS antenna (100) is placed to the point seeds (112) are released. In some embodiments of the present invention, the compensating for the offset must include compensating for the distance of the GPS antenna (100) in front of or behind where the seeds (112) are released, as well as the distance of the GPS antenna (100) left or right of where the seeds (112) are released. This compensation calculation will correct any directional deviation caused by the GPS antenna's (100) position relative to the point of seed (112) dispersal.

The GPS planting system further comprises a ready sensor (101) that indicates whether a planter (110) that contains the seeds (112) is ready to plant. When the planter (110) is not ready to plant, the ready sensor (101) outputs a signal to the microprocessor (104) and planting functions are suspended. In some embodiments of the present invention, the planter (110) is attached to a tractor (108) by way of a 3-point agricultural hitch that allows the planter (110) to be raised when it is not desirable to plant. When the planter (110) is raised, the ready switch sends an indication to the microprocessor (104) so that the microprocessor (104) pauses planting and seeds (112) are not wasted. It is sometimes necessary to raise the planter (110) during planting for such reasons as making a turn at the end of a field, traversing an obstacle such as a road, or to perform service on the planter (110). In these instances, as well as others, a ready sensor (101) mounted on the planter (110) will prevent wasting of seeds.

The ready sensor (101) is also used in embodiments of the present invention that employ coverage logging. Coverage logging is a function that tracks of which parts of the field have already been planted. A user can access a map of the field on an information display (103) that can show which areas of the field have already been planted. Coverage logging also provides other useful features such as calculating the number of acres that have already been planted and determining seed usage per acre. When the ready sensor (101) indicates the planter (110) has been lifted or is not ready to plant, coverage logging is automatically disabled. When the ready sensor (101) indicates the planter (110) is ready to plant, coverage logging is automatically re-enabled.

Some embodiments of the present invention use a mercury tilt switch as the ready sensor (101). The mercury tilt switch includes a small, shaped vial containing a small pool of mercury. The mercury is held in the lowest part of the vial by gravity. The mercury tilt switch also includes two electrical contacts that extend into the vial. One of the contacts is allowed to remain above the level of the mercury when the vial is level. When the vial is rotated the exposed contact is moved below the level of the mercury and a closed electrical circuit is formed. The mercury conducts electricity from one contact to the other one indicating a tilt condition. It should be noted that other embodiments of the present invention may use any type of position-indicating or tilt switch as the ready sensor (101).

To increase location accuracy of the GPS planting system, a receiver capable of receiving GPS correction information (102) is utilized. Some embodiments of the present invention use a Real Time Kinematic (RTK) receiver that increases location accuracy from a few feet to less than an inch. The GPS correction receiver (102) receives signals transmitted from a nearby base station tower. The base station tower receives GPS data from satellites, then compares the satellite data to known coordinates. An error difference calculation is made that compares the difference between the satellite data and the known coordinates. This error difference is transmitted to the GPS correction receiver (102) so that the GPS planting system can modify its GPS position using the error difference and obtain a more accurate actual position. The GPS correction receiver (102) outputs GPS correction information to the microprocessor (104).

The GPS planting system displays planting information to a user through an information display (103) that receives information from the microprocessor (104). The planting information displayed on the information display (103) includes cartographical information such as map that indicates the user's present position. The planting information displayed on the information display (103) also includes a map that overlays where a planting pass should be made.

The GPS planting system displays system information to a user by way of an operator interface (105). The operator interface (105) allows the user to quickly debug or troubleshoot the GPS planting system, and allows the user to monitor if the system is working. In some embodiments, the operator interface (105) can be a part of the information display (103) where system information is displayed to a user through a visual display (103). In other embodiments, the operator interface (105) is a separate device with system-specific displays or indicators.

The system information displayed to a user by the information display (103) can include, but is not limited, to the following: a seed release indicator that indicates when seeds are released from seed doors (111), a GPS indicator that indicates whether the microprocessor (104) is receiving GPS data, and a ready sensor indicator that indicates whether the ready sensor (101) has been tripped which further indicates the planter (110) is not ready to plant. Other system diagnostic information may be displayed to the user by the operator interface (105).

Data processing in the GPS planting system is performed by a microprocessor (104). The microprocessor (104) receives information from one or more components of the GPS planting system, performs calculations on the received information, and outputs signals to one or more components of the GPS planting system. In one embodiment of the present invention, the microprocessor (104) receives information from the GPS antenna (100), calculates where seeds (112) must be dropped, and outputs actuation signals to a seed door controller (107). In another embodiment of the present invention, the microprocessor (104) receives information from the GPS antenna (100) and GPS correction information from the GPS correction receiver (102), performs GPS position correction calculations, then outputs actuation signals to a steering controller (106) that steers a tractor (108) that is pulling a planter (110). If the planter (110) is a self-propelled planting unit, the steering controller (106) is attached to the steering system of the planter (110) and can steer the planter (110) directly. The GPS planting system is capable of automatically steering the tractor (108) or planter (110) along a proper planting path in a field. In other embodiments of the present invention, the steering controller (106) is capable of controlling the direction of the tractor (108) or planter (110), as well as controlling the velocity of the tractor (108) or planter (110).

The microprocessor (104) executes planting software that is written to perform the functions required by the GPS planting system. These functions include determining the location to drop seeds (112) and the time at which the seeds (112) must be dropped from the seed doors (111). In performing the seed drop time calculation, the microprocessor performs a drop prediction calculation to compensate for the tractor's (108) velocity and distance travelled between received GPS packets. In some embodiments, the microprocessor (104) also compensates for the time necessary for a seed (112) to fall from the seed doors (111) to the ground.

The microprocessor (104) performs the coverage logging features as described above. The microprocessor (104) can record and store data about elevation and boundaries in the field. Also, the microprocessor (104) can determine where the tractor (108) and planter (110) have already passed, and must pass for successful seeding.

The microprocessor (104) can be a single, multi-function data processing unit, or, in some embodiments of the present invention, may comprise a plurality of microprocessors (104) such as a GPS information processor, a seed program execution processor, and a steering controller (106) processor. For purposes of the present invention, the microprocessor (104) is a single, or a collection of data processing devices that execute software written to control functions of the GPS seed planting system.

When it is time to drop a seed (112), the microprocessor (104) outputs an actuation signal to the seed door controller (107). The seed door controller (107) acts as a switch designed to provide power to one or more seed door actuators (109) upon receiving the actuation signal from the microprocessor (104). In an embodiment of the present invention, the seed door controller (107) is a metal-oxide-semiconductor field-effect transistor (MOSFET) transistor that supplies voltage to the seed door actuators (109). Upon receiving an actuation signal from the microprocessor (104), the seed door controller (107) supplies voltage to one or more seed doors actuators (109), and the seed doors (111) release seeds (112). The seed door (111) opening and shutting sequence is illustrated in FIG. 7.

The seed door actuators (109) open and close the seed doors (111) when it is time to drop seeds (112). The seed door actuators (109) are mechanical devices that provide the motive force to open and close the seed doors (111). In one embodiment of the present invention, the seed door actuators (109) are mechanical solenoids that extend or retract a piston when voltage is delivered or terminated by the seed door controller (107). The piston contacts a portion of the seed door (111), or a seed door lever (FIG. 6, (145)) causing it to remain closed, and refracts the piston allowing the seed door (111) to fall open when a seed (112) must be dropped. The piston may be magnetized allowing for a retraction force to be exerted on the seed door (111) when the piston is retracted.

In another embodiment of the present invention, the seed door actuator (109) is an air valve solenoid that causes air to be blown on the back of a seed door (111), or prevents air from being blown on the back of a seed door (111). When air is blown on the back of the seed door (111), the seed door (111) remains closed. When the air is shut off, the seed door (111) falls open and the seed is released.

In yet another embodiment of the present invention, the seed door actuator (109) is a magnet that exerts a magnetic force on the seed door (111). The seed door (111) opens or closes when the magnet is energized, or de-energized.

Referring now to FIG. 2, there is shown a block diagram of the modes of a GPS planting system as according to one embodiment of the present invention. The GPS planting system executes software that causes the system to operate in different modes, each containing functions that allow the system to operate properly.

A diagnostic mode (113) is used to diagnose system problems, when performing maintenance, or inspecting the system. In diagnostic mode (113), other operating modes are disabled (116). The seed doors (FIG. 1, 6, 7 (111)) are actuated as according to their normal opening and shutting sequence (118) on a set cycle time. This allows the operator to visually observe the operation of the seed doors (FIG. 1, 6, 7 (111)) while the planter (FIGS. 1, 5 (110)) is stationary.

A pause mode (115) suspends operation of the seed doors (120) and temporarily suspends planting. The pause mode (115) can be called when the ready sensor has been triggered (119). The triggering of the ready sensor (119) indicates the planter (FIGS. 1, 5 (110)) has been raised, disengaged, or otherwise disabled (117). The pause mode (115) is used to retain seeds (FIG. 2, 121) currently held in the doors (121) when the planter (FIGS. 1, 5 (110)) is transported, or is crossing an obstacle such as a road. When planting is resumed, seeds (FIGS. 1, 7 (112)) can be dropped at the first and second planting positions that the planter (FIGS. 1, 5 (110)) encounters. Without the pause mode (115), seeds (FIGS. 1, 7 (112)) would be dropped whenever a planting position was traversed.

The primary program of the GPS planting system is the planting mode (114). This is the mode executed by the system when planting, and is described in FIG. 3, as discussed below.

Referring now to FIG. 3, there is shown a flowchart of the planting mode (114) of a GPS planting system as according to one embodiment of the present invention. When the planting mode (114) program is executed, a system initialization (122) occurs. System initialization includes initializing input/output (I/O) ports. The I/O ports are ports for transmitting or receiving information to or from components of the system. A seed drop timer is initialized, and a seed drop routine (FIG. 4 (133)) is initialized.

After system initialization (122), the GPS planting system is driven in a field along any course. The system can be driven in any direction. The system can be driven at any speed as it traverses the field. The planting mode (114) is able to determine planting locations regardless of the system's direction or velocity.

The microprocessor (FIG. 1 (104)) receives GPS information (123) from the GPS antenna (FIGS. 1, 5 (100)) and parses the GPS information for latitude, longitude, and velocity (124). The received GPS information gives the present location of the GPS antenna (FIGS. 1, 5 (100)) since that is the point of reception of the GPS signals. The position of the lower end of the planter seed tube (FIG. 6 (146)) is determined by correcting for the received GPS information (125). The corrections include correcting for the fore and aft errors caused by the difference in the mounting position of the GPS antenna (FIGS. 1, 5 (100)) relative to the lower end of the planter seed tube (FIG. 6 (146)), or seed disk when using a seed-metering unit, and correcting for situations when the vehicle on which the GPS antenna (FIGS. 1, 5 (100)) is mounted is being operated on a sloped surface, thereby tilting and moving the antenna horizontally. The corrected position for the lower end of the planter seed tube (FIG. 6 (146)) is then stored as the current position.

The planting mode (114) then determines the next planting position (126). In this step, the next planting position is determined by comparing the system's current position to a user-defined entry that indicates the desired planting positions. The user-defined entry is the location at which a user has specified seeds to be planted. This entry can be a ratio, such as specifying that at least one planting will within a given distance. The entry can also be a ratio specifying that a number of plantings will occur within a given distance. The planting mode (114) compares the current position to the next consecutive planting position.

The distance to the next planting position is calculated (127) after comparing the current position and next planting position. The system takes into account the current direction of travel when calculating the distance to the next planting position (127).

The planting mode (114) calculates the distance from the current position to the drop position for that planting position (128). The drop position is a calculated position that is where the machine must drop a seed (FIGS. 1, 7 (112)) after compensating for a seed-to-ground delay. The seed-to-ground delay is a time constant representing the amount of time it takes for a seed (FIGS. 1, 7 (112)) to reach the ground after the microprocessor (FIG. 1 (104)) has sent a signal to drop the seed (FIGS. 1, 7 (112)). The user can manually enter a pre-known seed-to-ground delay, or experimentally determine the seed-to-ground delay by recording the amount of time it takes a seed (FIGS. 1, 7 (112)) to reach the ground after the microprocessor (FIG. 1 (104)) has sent the seed drop signal.

The estimated time to dropping a seed (FIGS. 1, 7 (112)) is calculated (129) using the distance to the drop position after it has compensated for the seed-to-ground delay (128) and the velocity at which the system is travelling as received from the GPS information (123).

A check is made to see if the estimated time to drop is less than a user defined constant which is a minimum time set by the user (130). If the estimated time to drop is less than the user defined constant, the planting mode (114) returns to the step of receiving GPS information (123). If the estimated time to drop is greater than the user defined minimum time constant, the planting mode (114) sets a seed drop timer that counts down the estimated time to drop (131). Then, the program returns to the step of receiving GPS information (123).

Referring now to FIG. 4, there is shown a flowchart of a seed drop routine (133) as according to one embodiment of the present invention. The seed drop routine (133) checks to see if the seed drop timer is at zero (135). If the seed drop timer is at zero, then the routine drops seeds (136) and a seed drop signal is sent from the microprocessor (FIG. 1 (104)) to the seed door actuator (FIG. 1 (109)). If the seed drop timer is not at zero, then the timer is decremented (134).

Next, the routine (133) sets a system check flag (138) to check the direction the system is travelling, and the status of any system I/O devices such as buttons and the ready sensor (FIG. 1 (101)).

The final step of the seed drop routine (133) is to return to the planting mode (139).

Referring now to FIG. 5, there is shown a front elevation view of an exemplary tractor (108) and planter (110) that are used with a GPS planting system as according to one embodiment of the present invention. The tractor (108) is any agricultural tractor capable of operating in a crop field environment. The planter (110) is towed behind the tractor (110) and is connected to the tractor (108) by a hitch. In some embodiments of the present invention, the hitch is a 3-point hitch that facilitates easy lifting of the planter (110). Seeds (FIGS. 1, 7 (112)) are contained within a bin or a hopper (140) on the planter (110). In some embodiments of the present invention, the seeds (FIGS. 1, 7 (112)) are contained within a seed metering unit.

In embodiments that use a seed metering unit, the seed metering unit has a disk that picks up seeds (FIGS. 1, 7 (112)) at holes at certain places in the disk. The disk usually is driven by the wheels on the planter (110), but it could be driven by an electric motor instead. The method of planting the seeds (FIGS. 1, 7 (112)) at the proper location requires synchronizing the rotation of the disk with the seed metering unit's position over the ground so that it drops seeds (FIGS. 1, 7 (112)) at the right time. A rotary encoder attached to the disk transfers position information to the microprocessor (FIG. 1 (104) when a certain point on the encoder passes the sensor. At that point, a seed (FIGS. 1, 7 (112)) is dropped.

In this embodiment, the GPS planting system program receives its current position from the GPS antenna (100) and calculates the estimated time, including compensating for any delays or position corrections, to the next seed drop point. The GPS planting system reads the seed disk's current position from the encoder and calculates how fast to rotate the disk so that the estimated time until seed drop equals the estimated time to the next seed drop point. The GPS planting system determines how fast the seed disk's rotation must be to drop subsequent seeds (FIGS. 1, 7 (112)) at the proper points. Upon receiving new GPS information (FIG. 3 (123)) the GPS planting system recalculates some or all of the future seed disk rotation speeds.

In the illustrated FIG. 5, the GPS antenna (100) is mounted to the tractor (108). However, the GPS antenna (100) can be mounted anywhere on the system, and that mounting position will be corrected for by software executed by the microprocessor (FIG. 1 (104)) to determine the exact location of the planter seed tube (141).

Referring now to FIG. 6, there is shown a front elevation view of an exemplary planter seed tube (141) of a GPS planting system as according to one embodiment of the present invention. The planter seed tube (141) has seed doors (111) that, when closed, keep seeds (FIGS. 1, 7 (112)) from falling until the proper time. When opened, the seed doors (111) allow seeds (FIGS. 1, 7 (112)) to either: fall to the lower doors (111), or fall to the ground. The seed doors (111) are actuated by seed door actuators (109). The seed door actuators (109) can be mechanical solenoids that extend or retract a piston when voltage is delivered or terminated by the seed door controller (FIG. 1 (107)). The piston contacts a seed door lever (145) and keeps the seed doors (111) closed when pressing against the seed door lever (145), but allows the seed doors (111) to open when the piston retracts. The seed door levers (145) are connected to the seed doors (111) by way of seed door hinges (143). In this embodiment, voltage is delivered to the seed door actuators (109) by electrical wiring (144) that is connected to the actuators (109).

In other embodiments of the present invention, the seed door actuators (109) can be compressed air tubes that blow air onto the seed door levers (145). As long as air is blowing against the levers (145), the seed doors (111) remain closed. Once air is no longer blown against the seed door levers (145), the seed doors (111) open allowing seeds (FIGS. 1, 7 (112)) to fall. In this embodiment, compressed air is delivered to the seed door levers (145) by tubes (144) connected to a supply of compressed air, such as an air compressor or compressed air tank.

In yet other embodiments of the present invention, the seed door actuators (109) are magnets that hold the seed doors (111) closed, or allow them to open when the magnets are energized or de-energized. In this embodiment, electricity is delivered to the seed door actuators (109) by electrical wiring (144).

When released from the lower seed doors (111), seeds (FIGS. 1, 7 (112)) fall through the planter seed tube (141) and exit through the lower opening of the seed tube (146). The lower opening of the seed tube (146) is relatively close to the ground so that seeds (FIGS. 1, 7 (112)) do not bounce or significantly deviate from the intended position.

Referring now to FIG. 7, there is shown a plan view of an exemplary seed door (111) opening and shutting sequence as according to one embodiment of the present invention. The seeds (112) and seed doors (111) are contained within the planter seed tube (141). Reading this FIG. 7 from left to right, the sequence begins with both sets of seed doors (111) being shut, with a few seeds (112) resting on both sets of doors (111). At the time to drop seeds (112), the lower seed door (111) opens, the seeds (112) fall, then the seed door (111) shuts. After a small delay, the upper seed door (111) opens, the seeds (112) previously resting on the upper seed door (111) fall onto the lower door (111), and then the upper seed door (111) shuts. As the GPS system operates, more seeds (112) drop onto the upper seed doors (111) and the sequence restarts.

Referring now to FIG. 8, there is shown a front elevation view of an exemplary planter seed tube (141) of a GPS planting system as according to one embodiment of the present invention. The planter seed tube (141) has two sets of double seed doors (111) in a V-formation that, when closed, keep seeds (FIGS. 1, 7 (112)) from falling until the proper time. Seeds (FIGS. 1, 7 (112)) will typically rest at the bottom of the V formed by the seed doors (111) before being dropped. This allows the seeds (FIGS. 1, 7 (112)) to be in the optimum drop position and lessens the chance the seed doors (111) will interfere with dropping seeds. (FIGS. 1, 7 (112)).

When opened, the seed doors (111) allow seeds (FIGS. 1, 7 (112)) to either: fall to the lower doors (111), or fall to the ground. The seed doors (111) are actuated by seed door actuators (109). The seed door actuators (109) can be mechanical solenoids that extend or retract a piston when voltage is delivered or terminated by the seed door controller (FIG. 1 (107)). The piston is connected to linkages (147) that, in turn, connect to seed door levers (145). The seed door levers (145) keeps the seed doors (111) closed when pressing against the seed door lever (145), but allows the seed doors (111) to open when the piston retracts. The seed door levers (145) are connected to the seed doors (111) by way of seed door hinges (143). In this embodiment, voltage is delivered to the seed door actuators (109) by electrical wiring (144) that is connected to the actuators (109).

In other embodiments of the present invention, the seed door actuators (109) can be compressed air tubes that blow air onto the seed door levers (145). As long as air is blowing against the levers (145), the seed doors (111) remain closed. Once air is no longer blown against the seed door levers (145), the seed doors (111) open allowing seeds (FIGS. 1, 7 (112)) to fall. In this embodiment, compressed air is delivered to the seed door levers (145) by tubes (144) connected to a supply of compressed air, such as an air compressor or compressed air tank.

In yet other embodiments of the present invention, the seed door actuators (109) are magnets that hold the seed doors (111) closed, or allow them to open when the magnets are energized or de-energized. In this embodiment, electricity is delivered to the seed door actuators (109) by electrical wiring (144).

When released from the lower seed doors (111), seeds (FIGS. 1, 7 (112)) fall through the planter seed tube (141) and exit through the lower opening of the seed tube (146). The lower opening of the seed tube (146) is relatively close to the ground so that seeds (FIGS. 1, 7 (112)) do not bounce or significantly deviate from the intended position.

There is described and illustrated a new and improved GPS planting system, generally denominated herein. The inventive portions of the planting system include several subsystems that, when taken together, constitute an embodiment of the present invention. The above detailed description sets forth rather broadly the more important features of the present invention in order that its contributions to the art may be better appreciated.

As such, those skilled in the art will appreciate that the conception, upon which disclosure is based, may readily be utilized as a basis for designing other structures, methods, and systems for carrying out the several purposes of the present invention. It is important, therefore, that this description be regarded as including such equivalent constructions insofar as they do not depart from the spirit and scope of the present invention.

Although certain example methods, apparatus and articles of manufacture have been described herein, the scope of coverage of this application is not limited thereto. On the contrary, this application covers all methods, apparatus and articles of manufacture fairly falling within the scope of the invention either literally or under the doctrine of equivalents.

At least some of the above described example methods and/or apparatus may be implemented by one or more software and/or firmware programs running on a computer processor. However, dedicated hardware implementations including, but are not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should be noted that the example software and/or firmware implementations described herein may be optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of this disclosure are not limited to such devices, standards and/or protocols. Such systems are periodically superseded by faster or more efficient systems having the same general purpose. Accordingly, replacement devices, standards and/or protocols having the same general functions are equivalents which are intended to be included within the scope of this invention.

Directional terms such as “front”, “forward”, “back”, “rear”, “in”, “out”, “downward”, “upper”, “lower”, “top”, “bottom”, “upper”, “lower” and the like may have been used in the description. These terms are applicable to the embodiments shown and described herein. These terms are merely used for the purpose of description and do not necessarily apply to the position in which components or items within the present invention may be used.

Therefore, the foregoing is considered as illustrative only of the principles of a GPS planting system. Further, since numerous modifications and changes will readily occur to those skilled in the art, it is not desired to limit the GPS planting system to the exact construction and operation described, and accordingly, all suitable modifications and equivalents may be resorted to, falling within the scope present invention. While the above description describes various embodiments of the present invention, it will be clear that the present invention may be otherwise easily adapted to fit other configurations.

As various changes could be made in the above constructions without departing from the scope of the invention, it is intended that all matter contained in the above description shall be interpreted as illustrative and not in a limiting sense.

We claim:

1. An apparatus for planting seeds comprising:
a GPS antenna that receives GPS information, the GPS antenna being connected to a microprocessor;
a ready sensor that indicates whether a planter containing seeds to be planted is in a position to plant seeds, the ready sensor being connected to the microprocessor;
a seed door controller connected to a seed door actuator, the seed door controller causing the seed door actuator to open a seed door upon receiving an actuation signal from the microprocessor;
a planter seed tube that houses the seed doors and allows seeds to fall to the ground when the seed door is opened;
a steering controller that steers the planter, or a tractor pulling the planter, along a proper planting path in a field, the steering controller being connected to the microprocessor;
wherein the microprocessor receives the GPS information from the GPS antenna; parses the GPS information to determine latitude, longitude and velocity of the planter; determines the planter's present position by correcting for any fore and aft errors if the GPS antenna is not mounted directly above the lower end of the planter seed tube and correcting for any horizontal tilting of the GPS antenna if the planter is operating on a sloped surface; calculates the time and distance to a next planting position; calculates the position where a seed must be dropped in order to reach the next planting position after compensating for a seed-to-ground delay; and outputs an actuation signal to the seed door controller when the planter reaches the position where a seed must be dropped in order to reach the next planting position.

2. The apparatus of claim 1, further comprising a GPS correction receiver that receives signals from a nearby base station tower that contain an error difference calculation representing the difference between GPS satellite data and the base station's known coordinates.

3. The apparatus of claim 1, further comprising an information display connected to the microprocessor that displays information about the apparatus to a user.

4. The apparatus of claim 1, wherein the ready sensor outputs a signal to the microprocessor when the planter is not ready to plant causing the microprocessor to enter a pause mode.

5. The apparatus of claim 4, wherein the pause mode suspends operation of the seed door so that seeds are retained and held ready to be planted when planting resumes.

6. The apparatus of claim 1, wherein the steering controller is able to control the velocity of the planter.

7. The apparatus of claim 1, wherein the seed-to-ground delay is a time constant representing the amount of time it takes for a seed to reach the ground after the microprocessor has output the actuation signal to drop the seed.

8. A GPS seed planting system comprising:
a planter with a seed metering unit, the seed metering unit having a disk that picks up seeds at certain places in the disk;
a rotary encoder attached to the disk that transfers position information of the disk to a microprocessor;
a steering controller that controls the direction of the planter as the planter traverses a field, the steering controller receives actuation signals from the microprocessor;
a GPS antenna that is connected to the microprocessor;
wherein the microprocessor receives the disk position information from the rotary encoder and the GPS information from the GPS antenna;
wherein the microprocessor calculates the estimated time until the next seed drop point after compensating for fore and aft errors caused by the difference in the mounting position of the GPS antenna relative to point where a seed is dropped from the disk, and after compensating for the delay between the time the microprocessor outputs a seed drop command to the time the seed hits the ground;
wherein the microprocessor calculates how fast to rotate the disk so that the estimated time until the disk drops a seed equals the estimated time, after compensations, until the next seed drop point; and
wherein the microprocessor adjusts the disk's rotation speed so that the disk drops a seed at the estimated time, after compensations, of the next seed drop point.

9. The GPS seed planting system of claim 8, wherein the planter is pulled by a tractor and the steering controller controls the direction of the tractor as the tractor traverses the field.

10. The GPS seed planting system of claim 9, wherein the planter is attached to the tractor by a 3-point hitch that allows the planter to be lifted, and planting paused, when the tractor makes a turn at the end of the field or traverses an obstacle.

11. The GPS seed planting system of claim 8, wherein the disk is driven by the wheels on the planter or by a motor.

12. The GPS seed planting system of claim 8, wherein the disk is driven by an electric motor.

13. The GPS seed planting system of claim 8, wherein the rotary encoder transfers disk position information to the microprocessor when a certain point on the encoder passes a sensor.

14. The GPS seed planting system of claim 8, where upon receiving new GPS information the microprocessor recalculates some or all future disk rotation speeds.

15. A method for planting seeds in a field using GPS information comprising:
receiving GPS information from a GPS antenna;
parsing the GPS information for latitude, longitude, and velocity;
determining a current position by correcting the parsed GPS information;
determining a next planting position by comparing the current position to a user-defined entry that indicates desired planting positions;
calculating the distance to the next planting position;
calculating the distance from the current position to a drop position for the next planting position, where the drop position is the position a seed must be dropped after compensating for a seed-to-ground delay;
calculating an estimated time to drop from the current position to the drop position for the next planting position using the velocity parsed from the GPS information;
checking to see if the estimated time to drop is less than a minimum time constant set by the user, where if the estimated time drop is less than the minimum time constant returning to the step of parsing the GPS information, and if the estimated time to drop is not less than the minimum time constant setting a seed drop timer that counts down the estimated time until the seed is dropped; and
causing the seed to drop when the seed drop timer reaches zero.

16. The method of claim 15, wherein the current position is where a seed disk drops seeds.

17. The method of claim 15, wherein the current position is the position of the lower end of a planter's seed tube.

18. The method of claim 15, wherein correcting the parsed GPS information includes receiving an error difference between the received GPS information and known coordinates.

19. The method of claim 15, wherein correcting the parsed GPS information includes correcting for any fore and aft errors if the GPS antenna is not mounted directly above the lower end of the planter's seed tube, or where a seed disk drops seeds, and correcting for any horizontal movement or tilting of the GPS antenna.

20. The method of claim 15, wherein the user-defined entry specifying where the user wishes seeds to be planted is a ratio of plantings per n number of feet, where n is a user-defined variable.
